(19) United States
(12) Patent Application Publication
(10) Pub. No.: US 2014/0137352 A1
(43) Pub. Date: May 22, 2014

(54) Multipurpose Bendable Tool

(71) Applicants: Lydia K Golla, Cedar Park, TX (US); Patrick Golla, Cedar Park, TX (US)

(72) Inventors: Lydia K Golla, Cedar Park, TX (US); Patrick Golla, Cedar Park, TX (US)

(21) Appl. No.: 14/076,145

(22) Filed: Nov. 8, 2013

Related U.S. Application Data
(60) Provisional application No. 61/724,960, filed on Nov. 10, 2012.

(51) Int. Cl. A47K 7/02; B25G 1/02

(52) U.S. Cl. CPC A47K 7/02; B25G 1/02
USPC 15/160; 81/489

(57) ABSTRACT

A multipurpose bendable tool may include a portion of the tool having a flexible element including a shape retentive component that retains a shape to which the portion is bent. The portion can be bendable or formable, and may be adjusted into a variety of shapes which can be changed by a user. For example, the multipurpose bendable tool can be used to apply pressure to a surface via a head portion while substantially maintaining its shape, and can be fitted with a variety of attachments.

### CROSS REFERENCE TO RELATED APPLICATIONS

The present application claims priority to pending U.S. provisional patent application Ser. No. 61/724,960, filed Nov. 10, 2012, entitled “Multipurpose Bendable Tool”, the contents of which is hereby incorporated by reference in its entirety.

### BACKGROUND

The present disclosure generally relates to a multipurpose bendable tool.

### BRIEF DESCRIPTION OF THE DRAWINGS

FIG. 1 is a diagram of a multipurpose bendable tool, in accordance with certain embodiments of the present disclosure;

FIG. 2 is a diagram of a multipurpose bendable tool, in accordance with certain embodiments of the present disclosure;

FIG. 3 is a diagram of a multipurpose bendable tool, in accordance with certain embodiments of the present disclosure;

FIG. 4 is a diagram of a multipurpose bendable tool, in accordance with certain embodiments of the present disclosure;

FIG. 5 is a diagram of a multipurpose bendable tool, in accordance with certain embodiments of the present disclosure;

FIG. 6 is a diagram of a multipurpose bendable tool, in accordance with certain embodiments of the present disclosure; and

FIG. 7 is a diagram of a multipurpose bendable tool, in accordance with certain embodiments of the present disclosure.

### DETAILED DESCRIPTION

In the following detailed description of the embodiments, reference is made to the accompanying drawings which form a part hereof, and in which are shown by way of illustrations. It is to be understood that features of the various described embodiments may be combined, other embodiments may be utilized, and structural changes may be made without departing from the scope of the present disclosure. It is also to be understood that features of the various embodiments and examples herein can be combined, exchanged, or removed without departing from the scope of the present disclosure.

Bath and shower brushes can have firm or rigid handles, which can make it difficult to reach some parts of the body. For people with limited dexterity, such as those who are handicapped or arthritic, or with limited reach or flexibility, using a rigid handled bath brush to reach some areas of the body can be difficult and painful, if not impossible.

A multipurpose bendable tool, which may be used as a bath or shower brush is presented and examples are shown in the drawings and figures. While a shower brush is shown and discussed, the multipurpose bendable tool may also be or include an applicator, an exfoliator, a home or automobile brush, a mirror holder, or other tools that could be attached to the end of a bendable handle. The multipurpose bendable tool can have various applications and can be adapted to perform varying functions, such as via removable attachments or pads. In certain embodiments, a handle may be formed from a pliable material that can be bent or adjusted to a desired shape or angle. In a shower brush example, a user may bend a handle of the tool to an angle(s) allowing the user to clean parts of the body that may be difficult or painful to reach, such as the sole of a foot, the back of a knee, and so forth. In another example, a user can configure the tool with a dusting or cleaning attachment to clean hard to reach places on home furnishings, such as bookshelves, or entertainment centers, or may be configured to clean home baseboards, radiators, shelving (e.g. kitchen, bathroom, garage, etc.), ovens, drawers, and so forth. In yet another example, the tool can be configured to clean hard to reach places in vehicles, such as an engine compartment, or an undercarriage.

While the handle and a portion of the head of the tool may be bendable, the bendable portion can substantially hold a set position during use. For example, when the tool is used for cleaning, the tool can exert a pressure on a surface to scrub away unwanted material (e.g. dirt, oil, soap residue, excess skin, dust, tree sap, blood, tar, dead insects, etc.); while being used such that pressure is applied to the head of the tool, the tool can substantially maintain the set position or shape during use. However, the user can adjust the bendable portion at any time.

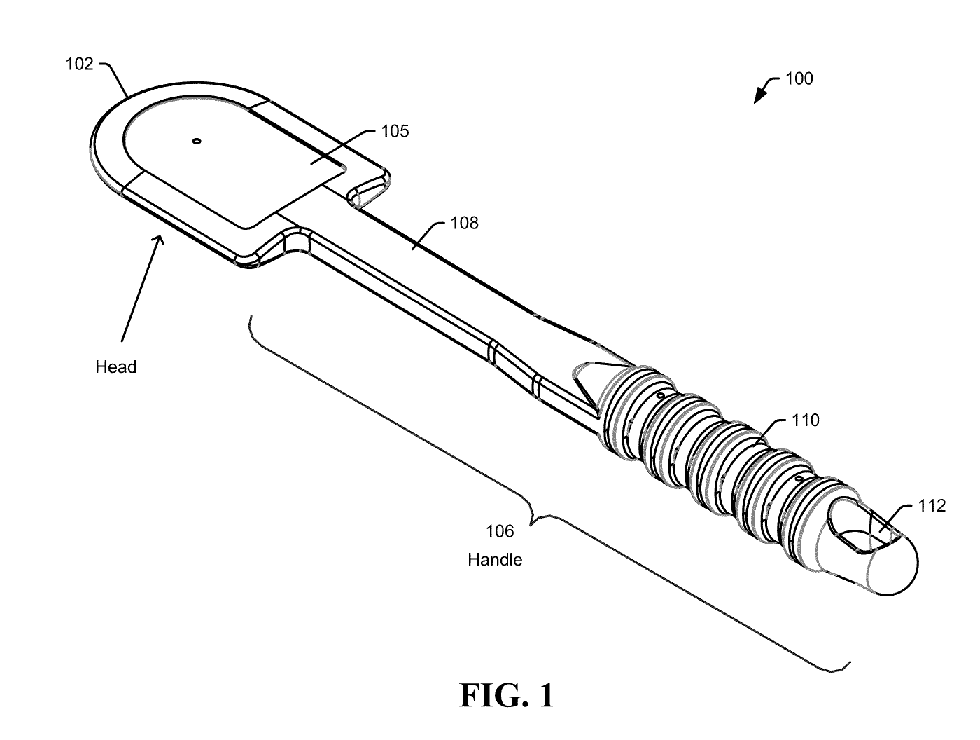

Referring to FIG. 1, a diagram of a multipurpose bendable tool is shown and generally designated 100. A multipurpose bendable tool 100 may be formed of multiple components, which can include a head portion 102 over which attachments can be placed, an attachment surface 105 onto which attachments can be affixed, a handle 106, a cavity (not shown) sized to receive an insert (not shown). The handle 106 can include a shaft 108, a hand grip 110, and an optional mounting loop 112. The hand grip 110 may have different shapes, such as ridges, bumps, grooves, curves, similar features, or any combination thereof. The hand grip 110 may have a rubberized surface or other type of surface that improves grip, such as via a covering, insert, or attachment to the handle 112.

The head portion 102 may come in a plurality of shapes, such as circular, rectangular, rounded, trapezoidal, or other shapes, and may have two or more sides. The sides may be of similar or different shapes than the other side(s) of the head portion 102, and may contain an embedded magnet(s) or magnetic material. The attachment surface 105, which may be grooved, textured, smooth, magnetic, concave or convex, and so forth, may have a similar shape as the head portion 102, although in some embodiments, the shapes may be different. For example, a two sided head portion 102 can have a rounded shape on each side, but the attachment surface 105 may be rounded on one side and rectangular on the other. In another embodiment, the tool 100 can include a head 102 with four sides, each having a different shape (e.g. rectangular, circular, trapezoidal, triangular, etc.). Further, the attachment surfaces 105 may have similar shapes as their respective sides. In the above example, the circular head portion may have a circular mirror affixed to the attachment surface, a triangular scrub pad placed over the triangular attachment portion, and so forth.

The handle 106 can be formed from a plastic material with a shape retentive insert. In some embodiments, the insert may be a metal alloy that can be flexible or formable that retains a position to which it is bent; that is, the insert is not elastic, resilient, or springy when bent into a selected position. The handle 106 may be supple, that is it can be bent without any sign of injury, such as cracking or snapping. The handle 106 may also be made from rubber, flexible composites, polymers such as ethylene vinyl acetate (EVA), or any other material that allows the portion with the metal alloy insert to remain flexible. Further, the handle 106 may be symmetric or asymmetric and can include ridges, bumps, curves, one or more colors, balancing weights, and so forth. In some embodiments, the handle 106 or head 102 can have a bladder (not shown) built into it or attached thereto to store a liquid, such as soap, lotion, medication, or paint. The liquid may be automatically (e.g. without human interaction), semi-automatically (e.g. with limited human interaction), or manually dispensed via an attachment that allows the liquid to exit the bladder. The bladder(s) may be filled via an opening, which may be located at the hand grip end of the handle or the head/attachment end of the tool, and the liquid contained therein may be dispensed via an opening in the attachment portion. In addition, the handle 106 may include an extendable portion, which can have a collapsing extension piece or an extension piece that may attach to main handle.

The multipurpose bendable tool 100 can be of unitary construction (insert not withstanding), or may include several removable components. In some embodiments, the head portion 102 may be separate from the handle 106, allowing the user to select from different styles (e.g. shapes, number of sides, sizes, materials, flexibility, colors, weight, etc.) of head/attachment portions 102 and handles 106. In some examples, the hand grip 110, which may be contoured to the shape of a hand and can include ridges or texturing, may be removed and replaced with a hand grip of a different style (e.g. size, texture, pattern, etc.), or with the same style.

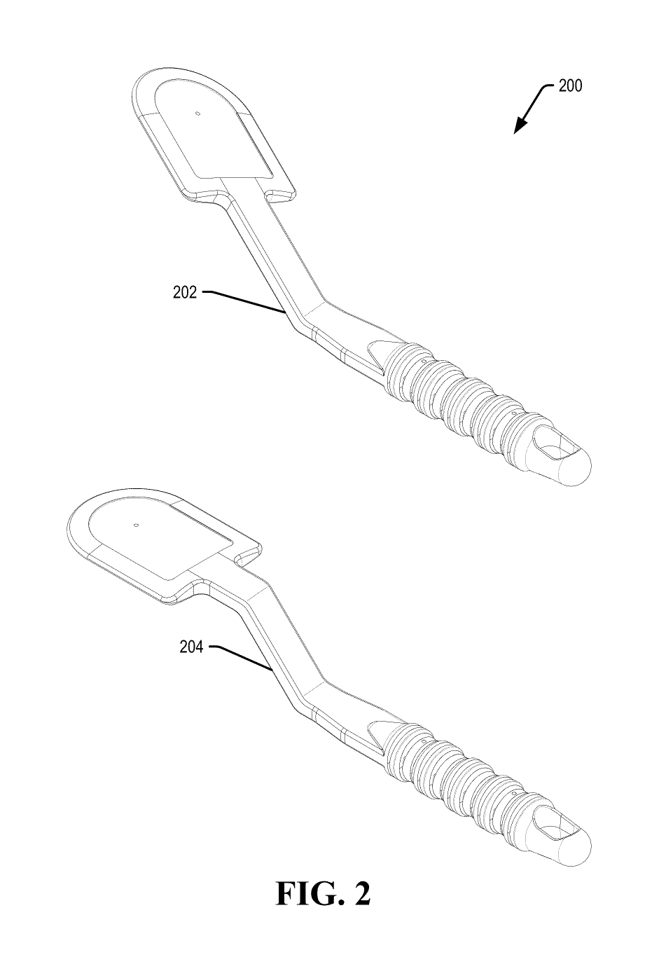

Referring to FIG. 2, a diagram of a multipurpose bendable tool is shown and generally designated 200. The system 200 can be an example implementation of the system 100. A user can bend the multipurpose bendable tool to various angles by adjusting the bendable portion, which can be the handle, the head, or a combination thereof, to various positions. For example, the tool may be bent to a first position 202, which later the tool may be bent to a second position 204. The number of positions is unlimited and can be bent at a single point or two or more points; in other examples, the tool may be bent in a curved fashion and not at a single point. In some embodiments, the tool can be flexible anywhere along the handle, be flexible at the junction between the handle and the head/attachment portion, be flexible at the head/attachment portion, or any combination thereof.

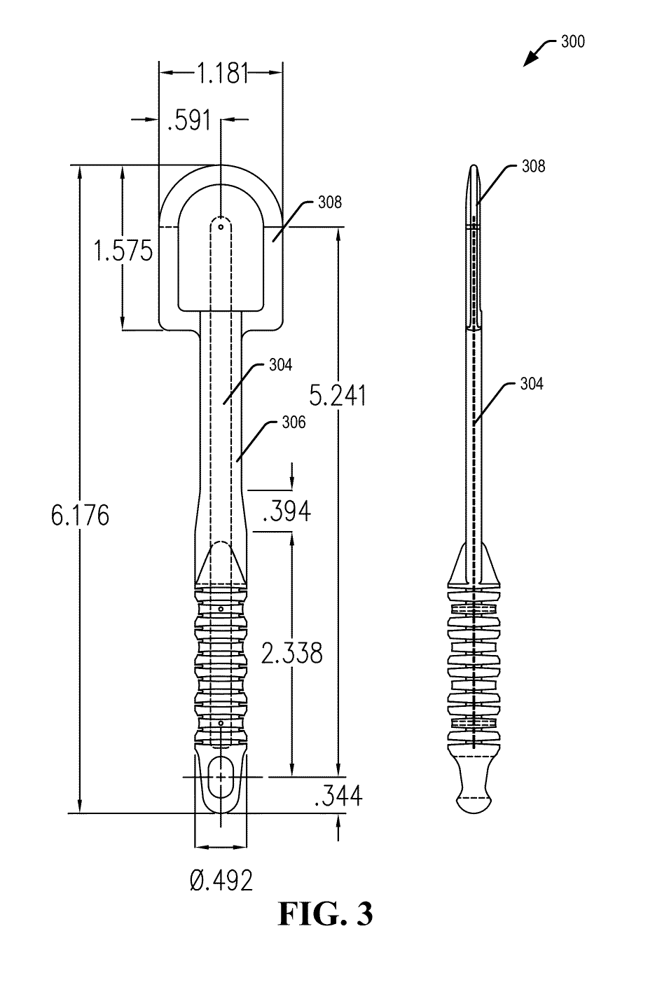

Referring to FIG. 3, a multipurpose bendable tool is shown and generally designated 300. The system 300 can be an example implementation of the system 100. A multipurpose bendable tool can include an insert 304, which may be a bendable material that retains a selected position. In some embodiments, the insert 304 may be affixed to or formed within all or a portion less than all of the head portion 308; the head portion 308/insert 304 combination can releasably coupled to the handle 306 via an attachment interface such as snap in, twist (screw), magnetic, compression, and so forth. In some cases, the selection of the head portion 308 can include the selection of the corresponding insert 304. For example, the head portion 308 can include a copper brush for removing rust from metal, and may include a stiff insert 304 so that more force can be transferred from the user to the surface. Alternately, the head portion 308 may include a bendable insert 304 and can include a soft filler material covered by terry cloth or microfiber for cleaning wood furniture, dusting fine china, or cleaning a video display. In other examples, the head portion 308 may include a stiff insert 304 and a pumice stone for exfoliating a user's heel, or a bendable insert 304 and a soft, absorbent material with a medication dispenser for wound care.

The insert 304 may be affixed to or formed within the handle 306, or may be affixed to or formed within the whole tool when the tool is a unitary piece. In some cases, the selection of a handle 306 can include the selection of the corresponding insert 304. In other examples, the insert 304, handle 306, and head portion 308 may all be separate, and may be interchangeable. Further, the insert 304 can be inserted into the handle 306 or head portion 308 via access points, such as at the grip end of the handle 306. The system 300 can be an example embodiment of a multipurpose bendable tool; other embodiments can have different grips, sizes, thicknesses, lengths, shapes, dimensions, and can include two or more releasably coupled pieces. In some embodiments, the head portion 308, or the junction between the handle 306 and the head 308 (e.g. the neck) may be flexible, while the rest of the handle 306, such as the shaft and the grip portions, may be rigid. The handle 306 can include wood, plastic, extruded polystyrene foam, and other materials having stiff or rigid properties.

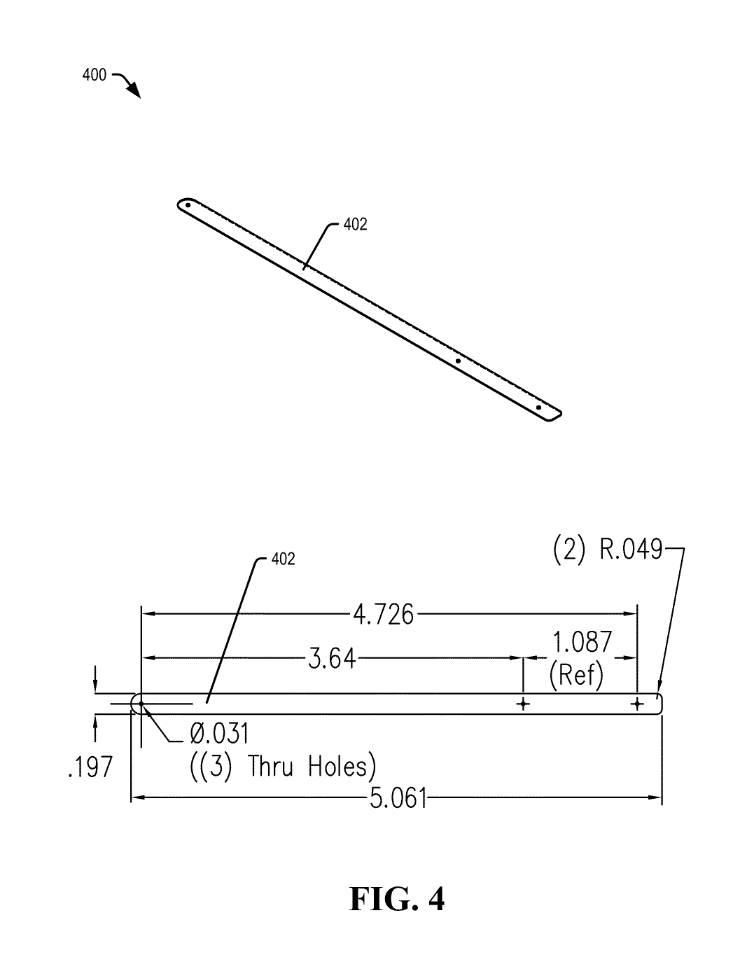

Referring to FIG. 4, a diagram of a multipurpose bendable tool is shown and generally designated 400. The system 400 can be an example implementation of the system 100. In an embodiment, an insert 402 may be a metal such as a metal alloy, lead, copper, aluminum, iron, silver, tin, nickel, or other alloys thereof. The insert 402 can also be galvanized steel, stainless steel, brass, silicon, liquid, gel or other material that can be configured to form a shape, bend, curve, or the like and to retain such until sufficient force is applied again to form a different configuration. The insert 402 can extend longitudinally through the tool and can be bendable for all or a portion less than all of the length of the tool 400, which can include a handle, an attachment portion, a junction of a handle with the attachment portion, and a hand grip. In some examples, the insert 402 can include multiple regions, and each region can have a different deformability than the other(s); some regions may be more or less bendable, while other regions may be rigid.

Referring again to FIG. 4, the insert 402 can have one or more holes, which may be used for placement during a manufacturing process, can be used to secure the insert 402 within a handle, or both. In some examples, the handle and head portion can be secured to the insert 402 without the holes, such as by forming a material around the insert or adding the insert within the handle or head during a manufacturing process. One example manufacturing process that could be used is injection molding. The system 400 can be an example embodiment of a multipurpose bendable tool; other embodiments can have different sizes, thicknesses, lengths, shapes, dimensions, number of holes, hole spacing, and so forth.

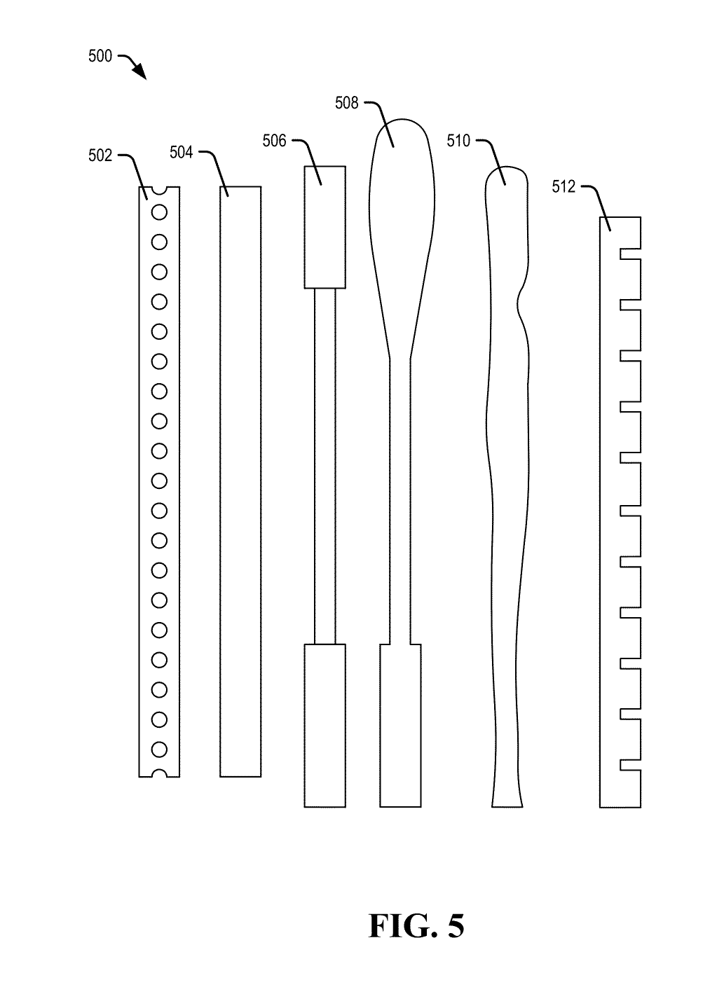

Referring to FIG. 5, a diagram of various embodiments of a multipurpose bendable tool is shown and generally designated 500. The system shows various embodiments of a flexible insert, which can be internal to a handle or attachment portion of a tool. A flexible insert may be built into the handle or attachment portion or may be inserted into such. A flexible insert can have a variety of shapes, sizes, and characteristics. For example, an insert 504 may be a substantially rectangular shape with rounded corners, which can have substantially uniform deformation and flexibility characteristics, while another insert 502 can include a plurality of holes or an insert 512 can have notches, which may increase deformability. Other variations of an insert can have a varying thickness along the edge of example inserts 506, 508, and 510, may have deformation and flexibility characteristics that can also vary along the edge. In yet other designs, a portion of example inserts 506, 508, and 510 that fits within a grip of a handle may be wider or thicker or less flexible than another region of the insert. Further, example inserts 506, 508, and 510 may be thicker or wider the areas supporting the attachment head 508 which can provide additional rigidity and reduce movement during tool use. In some cases, the inserts can be contoured based on the shape of the handle. The features of the example inserts disclosed herein may be combined in any combination, such as an insert with holes and a wider grip portion.

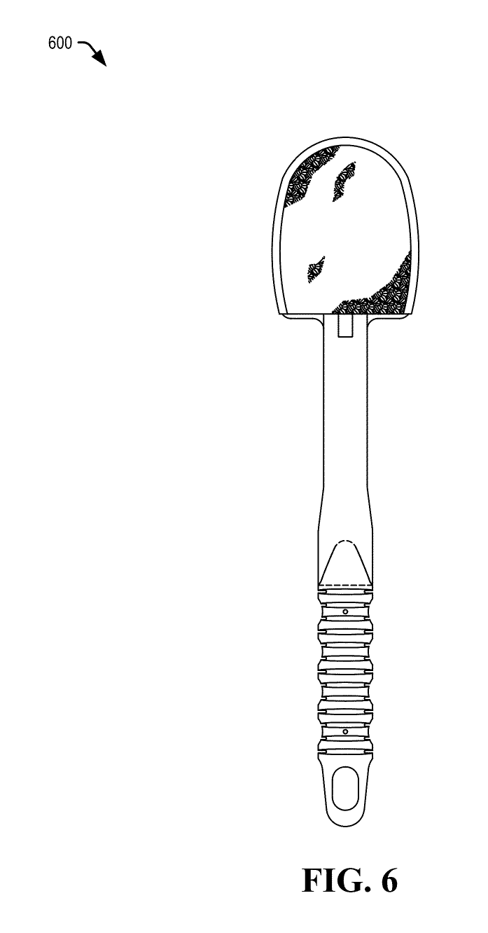

Referring to FIG. 6, a diagram of a multipurpose bendable tool is shown and generally designated 600. The system 600 can be an example implementation of the system 100. A head portion of a tool can have different attachments which can be affixed to portions of the tool, such as the handle or the head portion, via a slip on cover, a tie string, hook-and-loop fasteners (Velcro®), double sided tape, magnetics, slotted grooves, snaps, tongue in groove, or other attachments or combination thereof. The attachments can be removable pads, such as brushes, scrub pads or applicator pads, which can be machine or hand washable, and replaceable. Other examples of attachments can be sponges, lint removal paper, fly paper, sand paper, or mirrors. Some attachments can be liquid or foam dispensing, such as applicators dispensing lotion or soap, and in some embodiments, an attachment can be a sprayer, such as a shower head, connected to a water source which can be adjusted to provide different output patterns and pressures. In some cases, the attachments may be electric, or can be configured to store or use electric components, such as batteries and flashlights. The attachments may be reusable, recyclable, or disposable. The applicators listed herein are but a few examples of the wide array of applicators that can be adapted to, or specifically constructed for a multipurpose bendable tool.

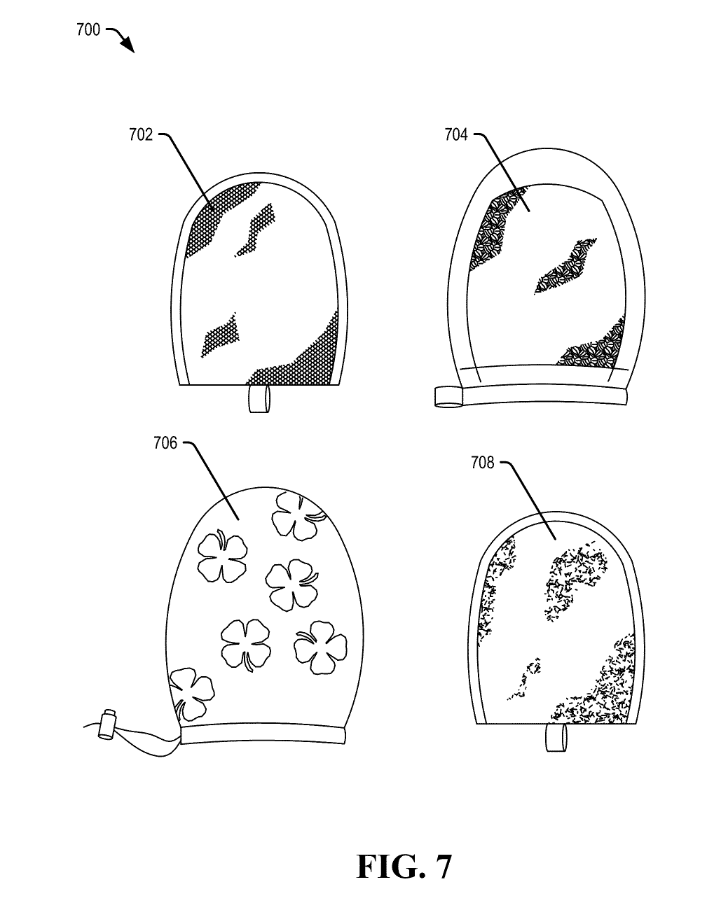

Referring to FIG. 7, a diagram of a multipurpose bendable tool is shown and generally designated 700. The system 700 can be an example implementation of the system 100. Attachments for the multipurpose bendable tool may have different shapes, styles, patterns, material, etc. In some examples, an attachment 702 may be a cloth or scrub applicator and attachment 704 may be a cloth applicator ringed with a stiffer, more abrasive material. An attachment 706 can be patterned, while another attachment 708 can have rough, abrasive surfaces.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A shower brush comprising:
a head component;
a handle component; and
at least a portion of the handle component is flexible and substantially retains a shape to which the handle component is bent.

2. The shower brush of claim 1 further comprising:
the handle component is capable of maintaining a set shape until sufficient force is applied to set another shape.

3. The shower brush of claim 1 further comprising:
the head component and the handle component are a unitary piece.

4. The shower brush of claim 1 further comprising:
at least a portion of the head component is flexible and substantially retains a shape to which the head component is bent.

5. The shower brush of claim 1 further comprising:
the handle component includes a flexible and shape retaining element.

6. The shower brush of claim 1 further comprising:
a scrubbing element attachable to the head component.

7. The shower brush of claim 1 further comprising:
a grip element on or part of the handle component.

8. The shower brush of claim 5 further comprising:
the flexible and shape retaining element is enclosed within the handle component.

9. The shower brush of claim 5 further comprising:
the flexible and shape retaining element includes a metal alloy.

10. The shower brush of claim 5 further comprising:
the flexible and shape retaining element extends throughout a majority of the handle component.

11. The shower brush of claim 5 further comprising:
the flexible and shape retaining element is enclosed within the handle component and at least partially within the head component.

12. The shower brush of claim 5 further comprising:
the flexible and shape retaining element is removable from the handle component and replaceable.

13. A tool apparatus comprising:
a handle having a flexible body including a shape retentive component that retains a shape to which the handle is bent.

14. The tool apparatus of claim 13 further comprising the shape retentive component is contoured based on a shape of the handle.

15. The tool apparatus of claim 13 further comprising:
the shape retentive component is enclosed within at least the handle and extends throughout at least a majority of the handle, and the shape retentive component includes a metal alloy.

16. The tool apparatus of claim 15 further comprising:
a head attached to the handle and configured to attach a removable component; and
the shape retentive component extends from the handle into at least a portion of the head.

17. The tool apparatus of claim 16 further comprising:
the head and the handle are a unitary piece in which the shape retentive component is enclosed.

18. The tool apparatus of claim 16 further comprising:
the tool apparatus is a shower brush and the removable component is a scrubbing element.

19. The apparatus of claim 16 further comprising:
the head includes a mechanism for affixing a removable component.

20. The apparatus of claim 19 further comprising:
the removable component includes a scrubbing apparatus.
